(19) United States
(12) Patent Application Publication
(10) Pub. No.: US 2002/0078155 A1
(43) Pub. Date: Jun. 20, 2002

(54) Method for receiving electronic messages by electronic device

(76) Inventors: Cheng-Shing Lai, Taipei Hsieng (TW); Jing-Song Wu, Taipei Hsieng (TW)

Correspondence Address: BACON & THOMAS, PLLC, 4th Floor, 625 Slaters Lane, Alexandria, VA, 22314-1176, US

(21) Appl. No.: 09/737,477

(22) Filed: Dec. 18, 2000

(51) Int. Cl. G06F 17/60

(52) U.S. Cl. 709/206

(57) ABSTRACT

A receiving method comprises storing at least one predetermined keyword in a first electronic device in advance, the keyword being related to one of a plurality of software installed in the first electronic device, appending a keyword in an electronic message sent from a remote second electronic device to the first electronic device, searching the predetermined keyword by a microprocessor of the first electronic device after the electronic message is received for finding a predetermined keyword matched to the keyword contained in the electronic message, finding a software related to the predetermined keyword if there is a matched predetermined keyword, and processing the electronic message by the related software. By utilizing this, user may immediately output the contents of the electronic message from an output device coupled to the electronic device, resulting in a saving of the time to perform a procedure for opening the electronic message. Most importantly, user is always aware of the received electronic message.

### FIELD OF THE INVENTION

The present invention relates to e-mail and more particularly to a method for receiving electronic messages by an electronic device.

### BACKGROUND OF THE INVENTION

Most of modern electronic devices have the capability of sending and receiving electronic messages. One of such electronic messages is e-mail. As designed that e-mail can contain both text and file(s) of any form which can be sent from one electronic device to another electronic device over for example the Internet. Such greatly enhances the message sending and receiving capability of e-mail. Also, a short message may be sent or received through a mobile phone. The contents of the short message may be a short text, a piece of music, an introductory page, or the like. Conventionally, a user has to open the electronic message received by an electronic device in order to output the same from an output device coupled to the electronic device. As a result, user may see the contents of the electronic message. As to the case of e-mail, a user has to open the email received by an electronic device in order to output the same from an output device coupled to the electronic device. Then, user also has to open the e-mail and the attached file(s) thereof in order to see the whole contents of the e-mail. This is a tedious procedure. Note that the attached file is readable only after the e-mail is open. This is a complicated design. As to a short message, user has to open it in order to show the same on a display screen of mobile phone. Similarly, user has to perform a storing process in order to store the contents of the received piece of music or introductory page in the memory of mobile phone. This also causes inconvenience.

### SUMMARY OF THE INVENTION

It is an object of the present invention to provide a process for receiving electronic messages by a first electronic device comprising storing at least one predetermined keyword in the first electronic device in advance, the keyword being related to one of a plurality of software installed in the first electronic device, appending a keyword in an electronic message sent from a second electronic device to the first electronic device, searching the predetermined keyword by a microprocessor of the first electronic device after the electronic message is received for finding a predetermined keyword matched to the keyword contained in the electronic message, finding the software related to the predetermined keyword if there is a matched predetermined keyword, and processing the electronic message by the related software.

The above and other objects, features and advantages of the present invention will become apparent from the following detailed description taken with the accompanying drawings.

### BRIEF DESCRIPTION OF THE DRAWINGS

FIG. 1 is a flow chart illustrating a process for receiving electronic messages by an electronic device according to the invention; and

FIG. 2 is a flow chart illustrating an embodiment of a process for receiving electronic messages by an electronic device according to the invention.

### DETAILED DESCRIPTION OF THE PREFERRED EMBODIMENTS

A process for receiving electronic messages in accordance with the invention is performed by an electronic device. In the embodiment, the electronic device is a computer, a mobile phone, or a personal digital assistant (PDA). However, it is appreciated by those skilled in the art that the electronic device may be any of other devices without departing from the scope and spirit of the invention. In the process, first store at least one predetermined keyword in the electronic device in advance wherein the keyword is related to one of a plurality of software installed in the electronic device. After the electronic device is activated, a microprocessor mounted in the control circuit of the electronic device is commanded to perform the following steps for receiving or sending electronic messages. In the embodiment, electronic messages may be e-mail or short messages. However, it is appreciated by those skilled in the art that electronic messages may be any of other forms without departing from the scope and spirit of the invention.

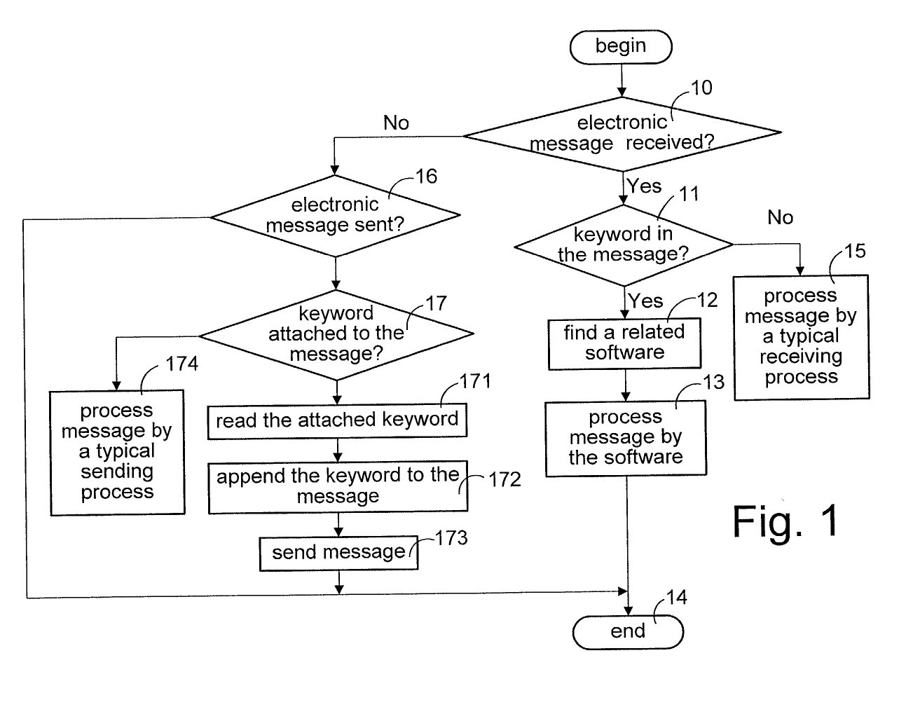

Referring to FIG. 1, the electronic messages receiving process is detailed below.

In step 10, a determination is made whether there is electronic message received. If no, goes to step 16. If yes, goes to step 11.

In step 11, a determination is made whether there is a predetermined keyword contained in the electronic message. If yes, goes to step 12. If no, goes to step 15.

In step 12, find a software related to the predetermined keyword in the electronic device. The process goes to step 13.

In step 13, process the electronic message by the related software. The process goes to step 14.

In step 14, the process ends.

In step 15, process the electronic message by a typical receiving process.

In step 16, a determination is made whether there is a sent electronic message. If yes, process goes to step 17. If no, process goes to step 14.

In step 17, a determination is made whether there is a keyword attached to the electronic message. If yes, process goes to step 171. If no, process goes to step 174.

In step 171, read the attached keyword. The process goes to step 172.

In step 172, append the keyword to the electronic message. The process goes to step 173.

In step 173, send the electronic message to a remote second electronic device. The process goes to step 14.

In step 174, process the electronic message by a typical sending process.

Note that the number of keywords may be equal to that of software installed in the electronic device. Alternatively, user may store a desired number of keywords depending on applications.

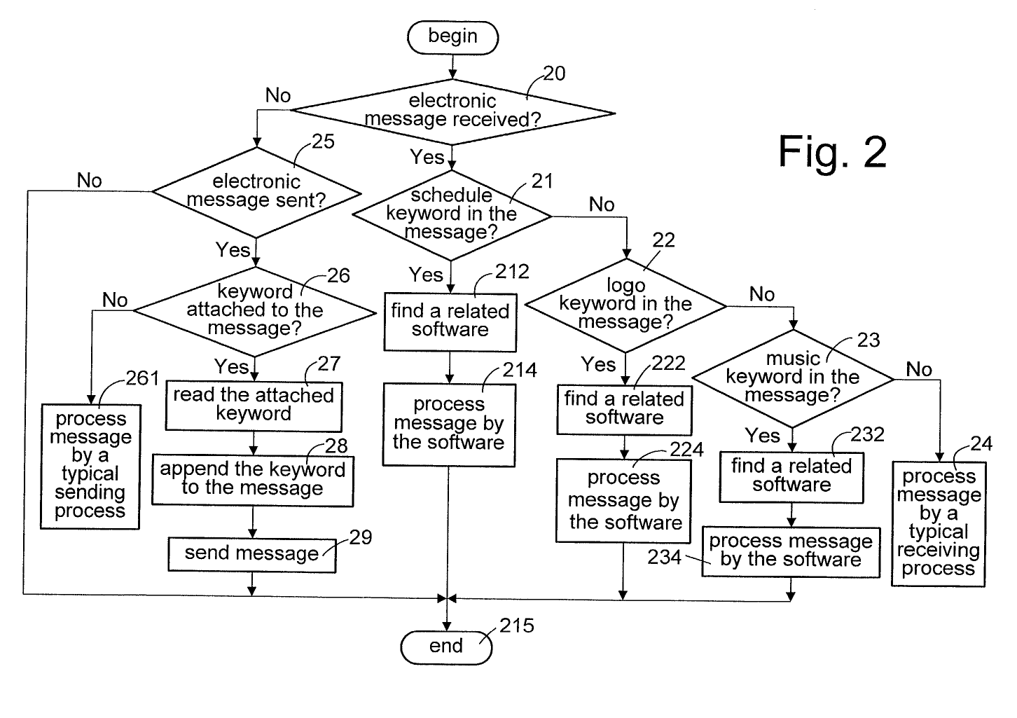

Referring to FIG. 2, there is a flow chart for illustrating an embodiment of a process for receiving electronic messages by an electronic device according to the invention. In the embodiment, the keywords comprise a schedule keyword (e.g., SET_SCHEDULE_ALARM), a logo keyword (e.g., SET_BMP_LOGO), and a music keyword (e.g., SET_MUSIC).

In step 20, a determination is made whether there is electronic message received. If no, goes to step 25. If yes, goes to step 21.

In step 21, a determination is made whether there is a predetermined schedule keyword contained in the electronic message. If yes, goes to step 212. If no, goes to step 22.

In step 212, find a software related to the predetermined keyword in the electronic device. The process goes to step 214.

In step 214, process the electronic message by the related software. The process goes to step 215.

In step 215, the process ends.

In step 22, a determination is made whether there is a logo keyword contained in the electronic message. If yes, process goes to step 222. If no, process goes to step 23.

In step 222, find a software related to the predetermined keyword in the electronic device. The process goes to step 224.

In step 224, process the electronic message by the related software. The process goes to step 215.

In step 23, a determination is made whether there is a music keyword contained in the electronic message. If yes, process goes to step 232. If no, process goes to step 24.

In step 232, find a software related to the predetermined keyword in the electronic device. The process goes to step 234.

In step 234, process the electronic message by the related software. The process goes to step 215.

In step 24, process the electronic message by a typical receiving process.

In step 25, a determination is made whether there is a sent electronic message. If yes, process goes to step 26. If no, process goes to step 215.

In step 26, a determination is made whether there is a keyword attached to the electronic message. If yes, process goes to step 27. If no, process goes to step 261.

In step 261, process the electronic message by a typical sending process.

In step 27, read the attached keyword such as a schedule keyword (SET_SCHEDULE_ALARM), a logo keyword (SET_BMP_LOGO), or a music keyword (SET_MUSIC). The process goes to step 28.

In step 28, append the keyword to the electronic message. The process goes to step 29.

In step 29, send the electronic message to a remote second electronic device. The process goes to step 215.

In brief, the invention comprises appending a keyword in an electronic message sent from a second electronic device to a first electronic device, searching the predetermined keyword by a microprocessor of the first electronic device after the electronic message is received for finding a predetermined keyword matched to the keyword contained in the electronic message, finding a software related to the predetermined keyword if there is a matched predetermined keyword, and processing the electronic message by the related software. By utilizing this, user may immediately output the contents of the electronic message from an output device coupled to the electronic device. As a result, time to perform a procedure for opening the electronic message is saved. Most importantly, user is always aware of the received electronic message.

While the invention has been described by means of specific embodiments, numerous modifications and variations could be made thereto by those skilled in the art without departing from the scope and spirit of the invention set forth in the claims.

What is claimed is:

1. A receiving process comprising:
storing at least one predetermined keyword in a first electronic device in advance, the keyword being related to one of a plurality of software installed in the first electronic device;
appending a keyword in an electronic message sent from a remote second electronic device to the first electronic device;
searching the predetermined keyword by a microprocessor of the first electronic device after the electronic message is received;
finding the predetermined keyword matched to the keyword contained in the electronic message;
finding the software related to the predetermined keyword if there is a match between the predetermined keyword and the keyword contained in the electronic message; and
processing the electronic message by the related software.

2. The receiving process of claim 1, wherein the microprocessor is mounted in a control circuit of the electronic device, the microprocessor being commanded to search the predetermined keyword after the electronic message is received, find the predetermined keyword matched to the keyword contained in the electronic message, find the software related to the predetermined keyword if there is a match between the predetermined keyword and the keyword contained in the electronic message, and process the electronic message by the related software.

3. The receiving process of claim 2, wherein the electronic message is processed by a typical receiving process when there is no keyword found in the electronic message.

4. The receiving process of claim 2, wherein when no electronic message is received as determined by the microprocessor, the microprocessor is commanded to perform the steps of:
determining whether there is a sent electronic message and ending the process if the determination is negative;
reading the attached keyword contained in the electronic message if the determination is positive;
appending the attached keyword to the electronic message;
sending the electronic message to the remote second electronic device; and
ending the process after the sending.

5. The receiving process of claim 3, wherein the electronic message is processed by the microprocessor by a typical sending process when no attached keyword is found in the electronic message as determined by the microprocessor.

6. The receiving process of claim 1, wherein each of the electronic devices is a computer.

7. The receiving process of claim 1, wherein each of the electronic devices is a mobile phone.

8. The receiving process of claim 1, wherein the electronic message is an e-mail.

9. The receiving process of claim 1, wherein the electronic message is a short message.
